(19) United States
(12) Patent Application Publication
(10) Pub. No.: US 2019/0139085 A1
(43) Pub. Date: May 9, 2019

(54) SYSTEMS AND METHODS FOR DYNAMICALLY DETERMINING CUSTOMIZED CONTENT ASSOCIATED WITH ENTITIES TO PROVIDE TO USERS IN A SOCIAL NETWORKING SYSTEM

(71) Applicant: Facebook, Inc., Menlo Park, CA (US)

(72) Inventors: Der Nien Lee, San Jose, CA (US); Sejal Kacharia, San Jose, CA (US); Parul Singh, Saratoga, CA (US); John David Dripps, Menlo Park, CA (US); Neal Suresh Vora, San Jose, CA (US)

(21) Appl. No.: 15/803,520

(22) Filed: Nov. 3, 2017

(51) Int. Cl. G06Q 30/02; G06Q 50/00

(52) U.S. Cl. CPC G06Q 30/0251; G06Q 30/0277; G06N 99/005; G06Q 50/01; G06Q 30/0242

(57) ABSTRACT

Systems, methods, and non-transitory computer readable media can receive a request from a user to access information associated with an entity through an interface supported on a particular surface. A plurality of candidate content items of a content type associated with the entity can be ranked for the user and the particular surface based on a machine learning model. At least one of the ranked plurality of candidate content items of the content type can be provided for display through the interface.

### FIELD OF THE INVENTION

The present technology relates to the field of social networks. More particularly, the present technology relates to computer networking techniques for dynamically providing customized content associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Various entities can be represented on the social networking system. For example, the social networking system may provide pages for various entities. Pages can be dedicated locations on the social networking system to reflect the presence of entities on the social networking system. Examples of entities can include companies, businesses, brands, products, artists, public figures, entertainment, individuals, etc.

### SUMMARY

Various embodiments of the present disclosure can include systems, methods, and non-transitory computer readable media configured to receive a request from a user to access information associated with an entity through an interface supported on a particular surface. A plurality of candidate content items of a content type associated with the entity can be ranked for the user and the particular surface based on a machine learning model. At least one of the ranked plurality of candidate content items of the content type can be provided for display through the interface.

In some embodiments, the machine learning model can be trained to predict a likelihood of engagement by the user with the plurality of candidate content items.

In certain embodiments, the machine learning model is trained based on features relating to one or more of: user attributes, entity attributes, attributes relating to interactions between users and entities, or surface attributes.

In an embodiment, the entity is represented as a page provided in a social networking system, and the page includes one or more sections each associated with a particular content type associated with the entity.

In some embodiments, the machine learning model is trained to rank candidate content items for each section of the page.

In certain embodiments, the content type relates to or more of: a call-to-action (CTA), an action bar, tabs, content items of a tab, cards of a tab, a workflow, an about section, a community section, a cover section, product information, or service information.

In an embodiment, the content type is the CTA, and the plurality of candidate content items are CTAs selected from a list of CTAs based on an objective associated with the entity.

In some embodiments, the objective associated with the entity is determined based on one or more of: a category associated with the entity or a template for creating a representation of the entity.

In certain embodiments, the particular surface is determined based on one or more of: an application or a platform.

In an embodiment, the application includes one or more of: a social networking application, a messaging application, a photo sharing application, or an external application, and the platform includes one or more of: a mobile platform or a desktop platform.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example dynamic surface content module configured to dynamically determine content associated with entities, according to an embodiment of the present disclosure.

FIG. 2 illustrates an example entity content determination module configured to determine entity content for a particular user on a particular surface, according to an embodiment of the present disclosure.

FIG. 3 illustrates an example user interface for dynamically determining content associated with entities, according to an embodiment of the present disclosure.

FIG. 4 illustrates an example first method for dynamically determining content associated with entities, according to an embodiment of the present disclosure.

FIG. 5 illustrates an example second method for dynamically determining content associated with entities, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Dynamically Determining Customized Content Associated with Entities to Provide to Users in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

Various entities can be represented on the social networking system. For example, the social networking system may provide pages for various entities. Pages can be dedicated locations on the social networking system to reflect the presence of entities on the social networking system. Examples of entities can include companies, businesses, brands, products, artists, public figures, entertainment, individuals, etc. Conventional approaches specifically arising in the realm of computer technology may provide the same or similar content of pages to various users, for example, without customization or personalization. For example, a page associated with an entity may be presented with the same content and/or format regardless of which user is viewing the page. Because a likelihood of engagement by a user with a page can vary depending on content presented to the user on the page, presentation of non-customized pages can detrimentally impact user engagement.

An improved approach rooted in computer technology can overcome the foregoing and other disadvantages associated with conventional approaches specifically arising in the realm of computer technology. Based on computer technology, the disclosed technology can dynamically determine content associated with an entity to provide to a particular user. Content associated with an entity (“entity content”) to provide to a user can be determined to increase a likelihood of user engagement with the entity. For instance, entity content can be dynamically determined to provide relevant information to a user at a particular point in time. Entity content can include different types of content (“content types”) associated with an entity. Examples of content types can include a call-to-action (CTA), an action bar, tabs, content or cards for each tab, a workflow, a cover section, information relating to products or services, etc. In some embodiments, an entity can be represented by a page in a social networking system. A page associated with an entity can include one or more sections, and each section can be associated with a particular content type. Each section can have one or more candidate content items of a corresponding content type that can be provided to users, and the one or more candidate content items for the section can be ranked for a particular user based on a likelihood of the user engaging with the section. In some embodiments, the candidate content items can be ranked based on machine learning techniques. For example, a machine learning model can be trained based on user attributes, entity attributes, etc. to predict a likelihood of a user engaging with an entity, for example, through its associated page. Entity content provided to a user can vary depending on a surface through which entity content is provided. A surface can be defined or determined based on an application, a platform associated with an application (e.g., mobile, desktop, etc.), etc. Entity content provided to a user can be dynamically determined for the user for a particular surface. In this manner, the disclosed technology can provide customized entity content to users and increase likelihood of users engaging with entities. Additional details relating to the disclosed technology are provided below.

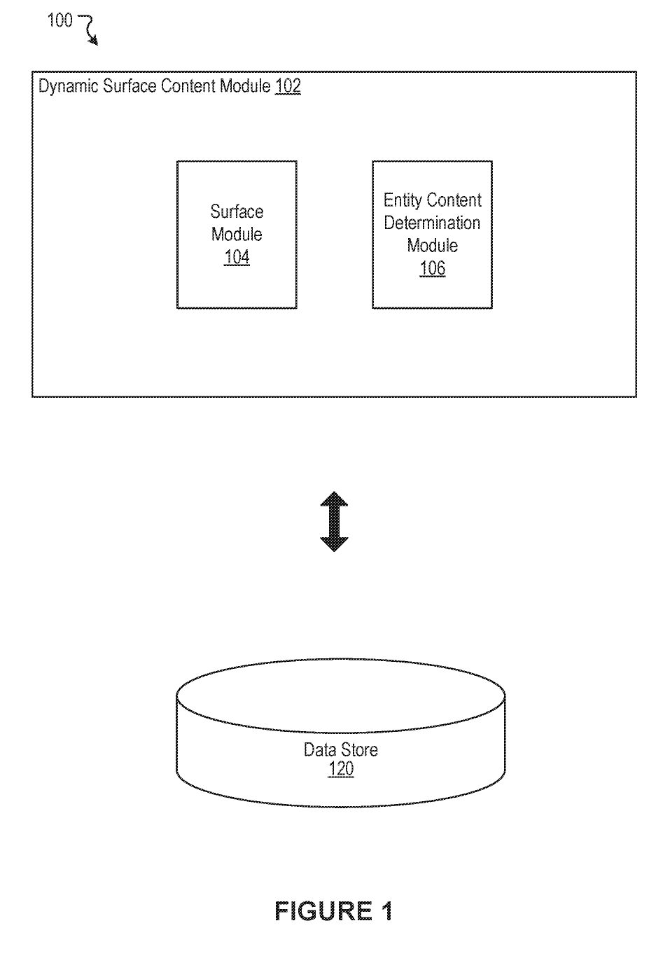

FIG. 1 illustrates an example system 100 including an example dynamic surface content module 102 configured to dynamically determine content associated with entities, according to an embodiment of the present disclosure. The dynamic surface content module 102 can include a surface module 104 and an entity content determination module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the dynamic surface content module 102 can be implemented in any suitable combinations. While the disclosed technology is described in connection with content associated with entities in a social networking system for illustrative purposes, the disclosed technology can apply to any other type of system and/or content.

The dynamic surface content module 102 can be implemented by a social networking system in some embodiments. Various entities can be represented in a social networking system. Examples of entities can include companies, businesses, brands, products, artists, public figures, entertainment, individuals, etc. Content associated with an entity (“entity content”) can include any content that relates to an entity. Entity content can include different types of content (“content types”) associated with an entity. As referenced, in some embodiments, an entity can be represented as a page in the social networking system. For instance, a page can be a profile or other representation of an entity. A page can include various sections, and entity content can be organized as or in the various sections of the page. For example, a section of a page can be associated with a particular content type. A page is one example of a representation of an entity, and an entity can be represented within the social networking system in various ways. The dynamic surface content module 102 can dynamically determine entity content for provision to a particular user. In addition, the dynamic surface content module 102 can vary entity content provided to a particular user depending on a surface through which the user accesses entity content.

The surface module 104 can receive requests for entity content from computing devices of users through various surfaces. A surface can indicate any user interface or any portion of a user interface through which entity content can be provided. A surface can be determined or defined based on one or more of the following: an application, a platform (e.g., mobile, desktop, etc.), an operating system (OS), a type of device, etc. In some embodiments, different applications associated with the social networking system can each be considered to be separate surfaces. Examples of applications can include a social networking application, a messaging application, a photo sharing application, a third party or external application, etc. In certain embodiments, different platforms for the same application can be considered to be separate surfaces. For instance, a mobile version of an application and a desktop version of an application can be considered to be separate surfaces. In an example, the surface module 104 can receive a request for entity content from a social networking application. For instance, the requested entity content can be a page of an entity. In another example, the surface module 104 can receive a request for entity content from a messaging application. For instance, the requested entity content can be a particular content type associated with an entity, such as information associated with products or services provided by the entity. In an additional example, the surface module 104 can receive a request for entity content from an external application in communication with the dynamic surface content module 102. Many variations are possible. All examples herein are provided for illustrative purposes, and there can be many variations and other possibilities.

The entity content determination module 106 can determine entity content to provide to a particular user on a particular surface. The entity content determination module 106 can dynamically determine appropriate entity content to provide to a user based on user attributes, entity attributes, etc. The entity content determination module 106 can vary the content and/or format of entity content provided on different surfaces. Functionality of the entity content determination module 106 is described in more detail herein.

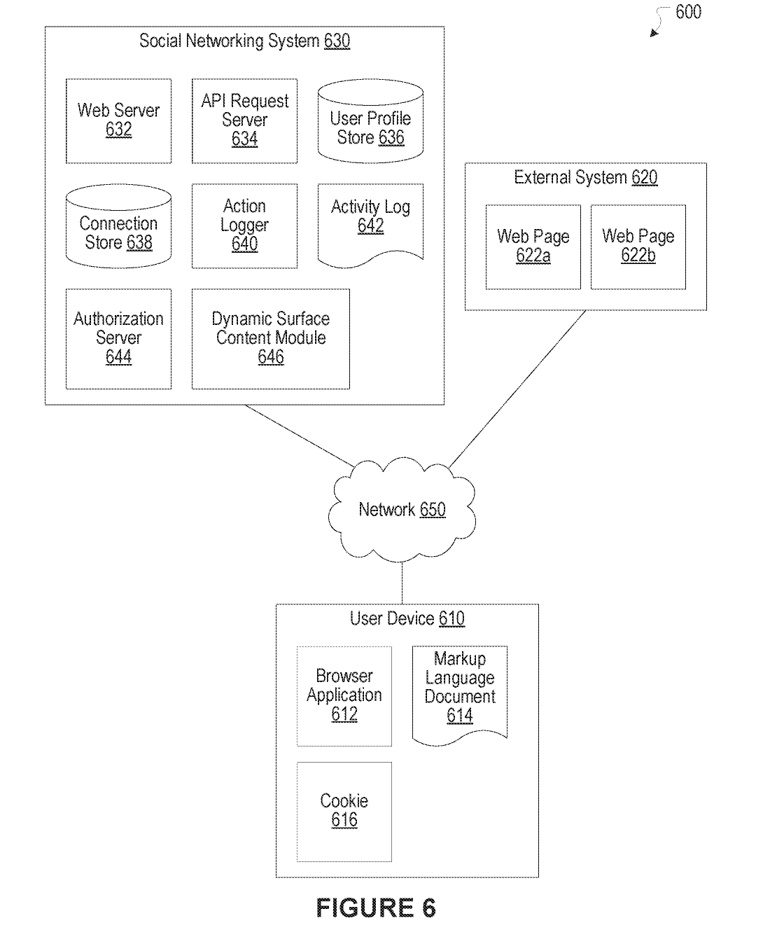

In some embodiments, the dynamic surface content module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the dynamic surface content module 102 can be, in part or in whole, implemented as software running on one or more computing devices or systems, such as on a server system or a client computing device. In some instances, the dynamic surface content module 102 can be, in part or in whole, implemented within or configured to operate in conjunction or be integrated with a social networking system (or service), such as a social networking system 630 of FIG. 6. Likewise, in some instances, the dynamic surface content module 102 can be, in part or in whole, implemented within or configured to operate in conjunction or be integrated with a client computing device, such as the user device 610 of FIG. 6. For example, the dynamic surface content module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the dynamic surface content module 102. The data maintained by the data store 120 can include, for example, information relating to entities, entity content, content types, content items, ranking, surfaces, pages, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the dynamic surface content module 102 can be configured to communicate and/or operate with the data store 120. In some embodiments, the data store 120 can be a data store within a client computing device. In some embodiments, the data store 120 can be a data store of a server system in communication with the client computing device.

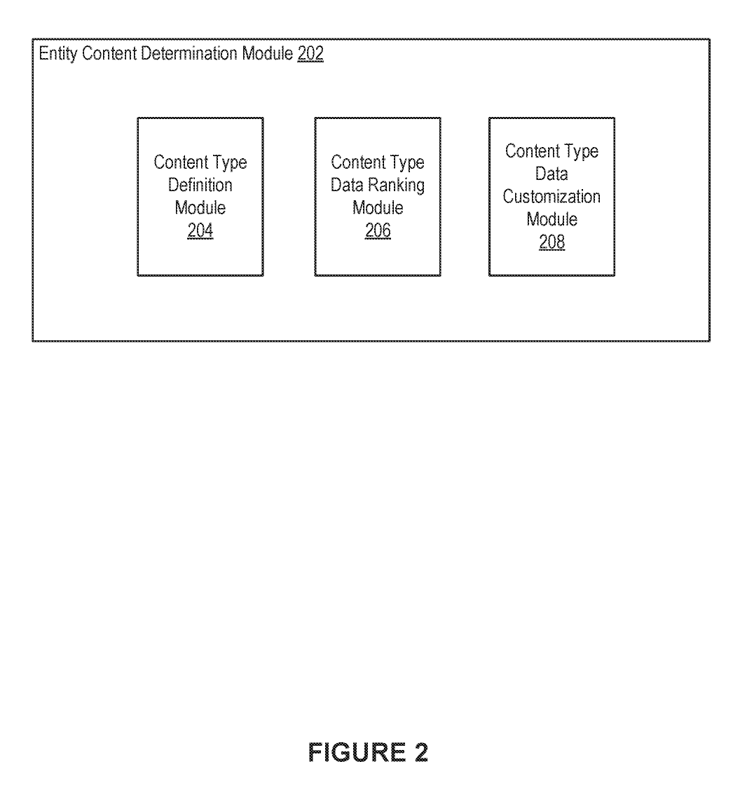

FIG. 2 illustrates an example entity content determination module 202 configured to determine entity content for a particular user on a particular surface, according to an embodiment of the present disclosure. In some embodiments, the entity content determination module 106 of FIG. 1 can be implemented with the example entity content determination module 202. As shown in the example of FIG. 2, the example entity content determination module 202 can include a content type definition module 204, a content type data ranking module 206, and a content type data customization module 208.

The content type definition module 204 can define one or more content types associated with entities. In some embodiments, there can be an entity definition for an entity that includes all entity content associated with the entity and that can be used across different applications associated with a social networking system. For instance, one or more content types associated with an entity can be included in the entity definition of the entity. In some embodiments, a content type associated with an entity may be provided to a user as a part of a page or another representation of the entity. In other embodiments, a content type associated with an entity may be provided from the entity definition of the entity, for example, without being included in a page or another representation of the entity.

Examples of content types can include a CTA, an action bar, tabs, content or cards for a tab, a workflow, product information, service information, etc. A CTA can indicate an action that can be taken in connection with an entity or a page of an entity. Examples of CTAs can include “call now,” “shop now,” “book now,” “make a reservation,” “buy tickets,” “contact us,” “learn more,” “get directions,” “purchase,” “order,” etc. An action bar can include a list of actions that can be taken in connection with an entity or a page of an entity. Examples of actions can include like, follow, share, save, message, etc. In some embodiments, the action bar can also include a CTA. Tabs can include a list of tabs that can provide related content or cards in connection with an entity or on a page of an entity. For example, content provided in each tab can be organized as one or more cards. Examples of tabs can include main or home, posts, photos, videos, reviews, events, offers, about, community, etc. An offers tab can provide information about various promotions or coupons associated with an entity. An about tab can provide information about an entity. A community tab can provide information about users with respect to an entity, such as a number of users who have liked the entity or a representation of the entity on the social networking system (e.g., a page). As mentioned above, each tab can include content that can be provided to users. A workflow can be provided in connection with an entity or a page of an entity. Examples of workflows can include a purchasing workflow, a ticketing workflow, a reservation workflow, an appointment workflow, a food ordering workflow, etc. In some embodiments, a workflow can be initiated in response to selection of a CTA by a user. Product information or service information can indicate information relating to products or services provided by a page of an entity. In some embodiments, different content types can be provided in the context of a page and various sections of the page. For example, each section of a page can be associated with a different content type. In other embodiments, a content type can be provided without a page, for example, in an external application. Many variations are possible.

The content type data ranking module 206 can rank one or more candidate content items for a content type. For each content type, there can be one or more candidate content items or pieces of information that can be provided. For example, for a CTA, there can be a list of candidate CTAs that can be provided for a page of an entity. In some embodiments, candidate CTAs can be specified by an administrator associated with an entity. In other embodiments, candidate CTAs can be selected from available CTAs based on a category associated with an entity, a template used to create a representation of an entity (e.g., a page), etc. A template can specify default fields and/or layout of a representation of an entity, such as default CTAs and tabs. For example, a page of an entity that is a restaurant can be created from a restaurant page template. For an action bar, there can be a list of candidate actions that can be provided for an entity. For tabs, there can be a list of candidate tabs that can be provided for an entity. For content to be provided for each tab, there can be one or more candidate items of content or candidate cards. As an example, if an entity is a restaurant, there can be a menu tab, and the menu tab can include one or more menu items as candidate items of content. A workflow can also include one or more candidate content items provided in connection with completing the workflow. As an example, a food ordering workflow can provide one or more menu items. For product information, there can be one or more candidate products that can be provided for an entity. Similarly, for service information, there can be one or more candidate services that can be provided for an entity. In some embodiments, a content type can include one or more pieces of information, and the pieces of information may be ranked for a user. As an example, an about section that provides overview information about an entity can include various pieces of information about the entity, such as a location, a website, etc., and the pieces of information about the entity can be ranked. In certain embodiments, filtering can be applied to available content items for a content type to select candidate content items for the content type. Filtering can be performed based on various criteria.

The content type data ranking module 206 can train one or more machine learning models to rank candidate content items or pieces of information for content types. For example, the candidate content items for content types can be ranked for a particular user and a particular surface based on a likelihood of a user engaging with the content types. In some embodiments, a machine learning model can be trained based on training data that includes information relating to users, entities or representations of entities on the social networking system (e.g., pages), content types, content items for content types, surfaces, labels indicating whether users have engaged with content types or entities, etc. The training data can include various features. For example, features can relate to user attributes, entity attributes, attributes relating to interactions between users and entities (“user-entity interaction attributes”), surface attributes, etc. User attributes can include any attributes associated with users. Examples of user attributes can include a location (e.g., a country, state, county, city, etc.), an age, an age range, a gender, a language, interests (e.g., topics in which the user has expressed interest), a computing device, an operating system (OS), social context information, etc. The social context information can indicate activities of a user or a user's connections in the social networking system. Entity attributes can include any attributes associated with entities or representations of entities, such as pages. Examples of entity attributes can include a category, a location (e.g., a country, state, county, city, etc.), operating hours, contact information (e.g., phone number, address, email address, etc.), an objective (e.g., specified or inferred), a number of connections or followers, a template, etc. The category can indicate a category associated with an entity, such as a restaurant, a store, a movie, etc. The template can be a template from which a representation of an entity (e.g., a page) can be created. Examples of templates can include a restaurant template, a store template, etc. User-entity interaction attributes can indicate prior engagement or interactions between users and entities. For example, user-entity interaction attributes can include engagement or interactions between users and representations of entities (e.g., pages). As another example, user-entity interaction attributes can include engagement or interactions between users and particular content types associated with entities. Surface attributes can include any attributes associated with surfaces. Weights associated with various features used to train the machine learning model can be determined. The content type data ranking module 206 can retrain the machine learning model based on new or updated training data. In some embodiments, the content type data ranking module 206 can train a single machine learning model for all content types associated with entities. In other embodiments, the content type data ranking module 206 can train a separate machine learning model for each content type associated with entities. In some embodiments, the content type data ranking module 206 can train a single machine learning model for all surfaces associated with entities. In other embodiments, the content type data ranking module 206 can train a separate machine learning model for each surface associated with entities. Many variations are possible.

The content type data ranking module 206 can apply the trained machine learning model to rank candidate content items or pieces of information for a content type for a particular user on a particular surface. For example, the trained machine learning model can be applied to feature data relating to the particular user, an entity associated with the content type or a representation of the entity, the content type, candidate content items for the content type, and/or the particular surface. For example, the trained machine learning model can output a ranking or a score for each candidate content item for the content type. The ranking or the score can be indicative of a likelihood of the particular user engaging with the content type. The content type data ranking module 206 can rank candidate content items based on respective scores. In certain embodiments, the content type data ranking module 206 may apply a filter to the ranked candidate content items to remove content types, such as CTAs, that are not relevant to the user. For example, a CTA for buying movie tickets may be high ranked, but purchase of movie tickets may not be provided in a geographical area in which the user is located. In some embodiments, only the top ranked candidate content item can be provided to the user. In other embodiments, a candidate content item can be provided to the user if the score for the candidate content item satisfies a threshold value. The candidate content items that satisfy the threshold value can be provided to the user on the surface based on an order of the ranking.

In certain embodiments, the content type data ranking module 206 can train the machine learning model to determine a number of content items for a content type to provide to a user. In some cases, providing more than a certain number of content items can decrease a likelihood of a user engaging with a content type or an entity. For example, a user may be more likely to engage with a content type when 3 content items are provided to the user as opposed to 4 content items. Accordingly, a number of content items to provide to a user can be determined based on various features as discussed above. One or more machine learning models discussed in connection with the dynamic surface content module 102 and its components can be implemented separately or in combination, for example, as a single machine learning model, as multiple machine learning models, as one or more staged machine learning models, as one or more combined machine learning models, etc.

The content type data ranking module 206 can train a machine learning model for pages in particular. As described above, a page can include various sections. For example, sections of a page can include a CTA section, an action bar section, a tab section, an about section, a cover section, etc. A cover section may be featured at the top of a page and may include a cover photo and other information. The content type data ranking module 206 can train a machine learning model to rank content items for various sections of pages based on a likelihood of users engaging with the various sections of the pages. For instance, the content type data ranking module 206 can train a machine learning model as described above. The machine learning model can rank candidate content items for a content type associated with a particular section of a page. For example, the machine learning model can rank one or more candidate CTAs for the CTA section of a page. In some cases, one or more candidate CTAs can be filtered prior to ranking in order to exclude CTAs that may not be relevant to a particular entity. In some embodiments, candidate CTAs can be selected from available CTAs based on an objective associated with an entity. An objective associated with an entity may indicate what the entity wishes to accomplish within the social networking system (e.g., sell products, take reservations, etc.). An objective may be specified by an entity or can be inferred or determined based on various factors. As an example, factors for inferring an objective of an entity can include a category and/or a template associated with the entity. As mentioned above, a template can be used to create a page. For example, a restaurant page can be created from a restaurant template, a store page can be created from a store template, etc.

The machine learning model can also rank candidate content items for other sections of a page. As an example, the machine learning model can rank one or more candidate cards to include in a main or home tab. The home tab can include default or main content provided for a page. Content in the home tab can be organized as one or more cards. For example, the home tab can include a card for posts, a card for reviews, a card for upcoming events, etc. The machine learning model can rank candidate cards for the home tab, and one or more of the ranked candidate cards can be provided in the home tab based on an order of the ranking. Similarly, the machine learning model can rank candidate content items for other tabs of a page. As another example, the machine learning model can rank candidate pieces of information for a cover section. Examples of candidate pieces of information for the cover section can include a photo carousel, a CTA, a video, etc. As a further example, the machine learning model can rank candidate pieces of information for an about section. Examples of candidate pieces of information the about section can include a location, a website, a phone number, a description, etc. At least some of the ranked candidate content items can be provided to a user based on the ranking, as described above. Many variations are possible.

The content type data customization module 208 can further customize entity content for a particular user. In some embodiments, entity content can be customized based on social context information. As an example, the content type data customization module 208 can provide information relating to social context information along with content items provided for a content type. For instance, if a CTA for making a reservation is provided to a user for a restaurant, social context information indicating that some of the user's connections have also made reservations at the restaurant can be provided in connection with the CTA. As another example, the content type data customization module 208 can customize or tailor a workflow for a particular user based on social context information. For instance, a user may have selected a CTA for buying movie tickets, and a ticketing workflow can be initiated. Social context information for the user can indicate that some of the user's friends have purchased tickets for a particular showing at a location. The ticketing workflow can be customized for the user to suggest purchasing tickets for the same movie showing. If the user's friends' seat information is available, the ticketing workflow can also suggest which seats to reserve. Such customization can help the user in decision making and increase a likelihood of the user engaging with an entity, for example, by completing the workflow. The content type data customization module 208 can also customize entity content based on other information associated with users and entities.

The entity content determination module 202 can dynamically determine entity content for various context, for example, through ranking by the content type data ranking module 206 and customization by the content type data customization module 208. As described above, the entity content determination module 202 can determine entity content to provide to a user based on contextual information associated with users and entities. The contextual information can include, for example, geolocation information, time information, user attribute information, user connection information, entity or page attribute information, surface information, and the like. As an example relating to geolocation information, if a user is in close proximity to a restaurant entity, the user is more likely to visit the restaurant. Accordingly, the entity content determination module 202 can rank tabs that relate to dining at the restaurant more highly than other tabs. For instance, the entity content determination module 202 can rank a menu tab more highly than other tabs, and rank CTAs such as “call now” or “get directions” more highly than other CTAs. In this way, the entity content determination module 202 provide entity content that increases a likelihood of a user interacting or transacting with an entity. As another example relating to time information, if entity content for a restaurant entity is requested after operating hours, the entity content determination module 202 can provide a CTA and/or a workflow that does not relate to ordering food from the restaurant. As an additional example user attribute information, if a user has dietary restrictions or food preferences, menu items that are more relevant to the user can be ranked more highly. As a further example relating to user connection information and page attribute information, if an entity is a movie theater, the entity content determination module 202 can customize a ticketing workflow to suggest movie showings a user's connections are attending and/or seats next to the user's connections. The entity content determination module 202 can also dynamically determine appropriate entity content based on surface information. As an example, if entity content is requested from a messaging application surface, users are more likely to want to communicate with an entity, and content items relating to communication can be ranked more highly than other content items. For instance, CTAs for communicating with the entity can be ranked more highly. As another example, if entity content is requested from an external application surface, candidate content items for a requested content type can be ranked and provided through the external application surface. For instance, an external application can be a restaurant information/review application, and menu items for a restaurant entity can be ranked and provided to the external application. Many variations are possible.

In this way, the disclosed technology can customize entity content to be provided to a user. Entity content can include different content types, and the disclosed technology can rank and customize content items for each content type. For example, the disclosed technology can provide information or data that is relevant to a particular user at a specific point in time, which can lead to increased engagement by the user with an entity. As another example, the disclosed technology can customize entity content for a particular surface. Accordingly, entity content associated with the same entity can be tailored as appropriate for a particular surface. All examples herein are provided for illustrative purposes, and there can be many variations and other possibilities.

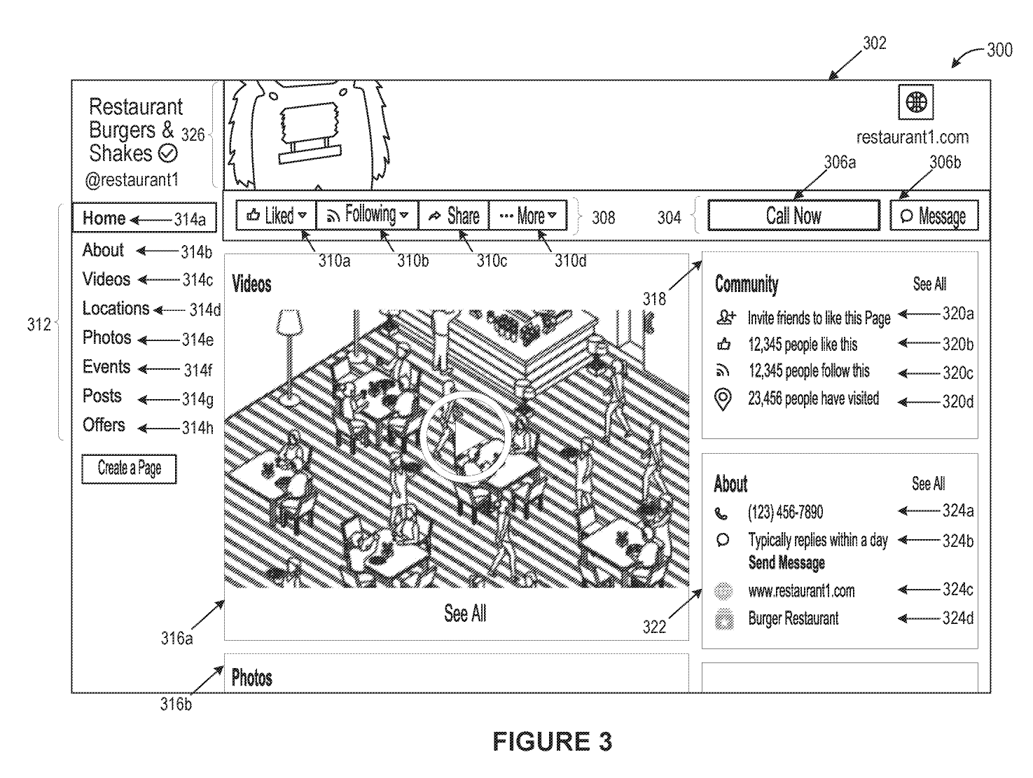

FIG. 3 illustrates an example user interface 300 for dynamically determining content associated with entities, according to an embodiment of the present disclosure. The user interface 300 illustrates a page 302 of an entity. Content items or pieces of information included in each section of the page 302 can be selected for presentation based on ranking and customization by the dynamic surface content module 102, as discussed herein. For instance, candidate content items for each section can be ranked for a particular user and a particular surface, and then selected for presentation as content that is customized for the user. A page is shown as an example representation of an entity for illustrative purposes, and an entity can be represented in many ways in a social networking system. In the example of FIG. 3, the entity is a restaurant entity. Sections of the page 302 include a CTA section 304, an action bar section 308, a tab section 312, a community section 318, an about section 322, and a cover section 326. Each section can be associated with a particular content type. The page 302 also presents content of a home tab 314a. In the example of FIG. 3A, the content of the home tab 314a includes one or more cards 316a, 316b. The CTA section 304 includes one or more CTAs 306a, 306b. The action bar section 308 includes one or more actions 310a, 310b, 310c. The action bar section 308 can also include an icon 310d to access additional actions. The tab section 312 includes one or more tabs 314a-314h. Each tab of the tabs 314a-314h can have content that can be presented on the page 302 to a user when the tab is selected. For example, the home tab 314a is selected as the default when the page 302 is accessed by a user on a surface. Each card for the home tab 314a can be associated with a particular content type. For example, the card 316a is associated with videos, and the card 316b is associated with photos. In some embodiments, content included in the cards 316a, 316b can relate to content provided by the different tabs 314. For example, content in the card 316a can relate to content provided by the videos tab 314c, and content in the card 316b can relate to content provided by the photos tab 314e. The community section 318 includes one or more information items 320a-320d. The about section 322 includes one or more information items 324a-324d. The cover section 326 can also include one or more content items, such as a cover photo. All examples herein are provided for illustrative purposes, and there can be many variations and other possibilities.

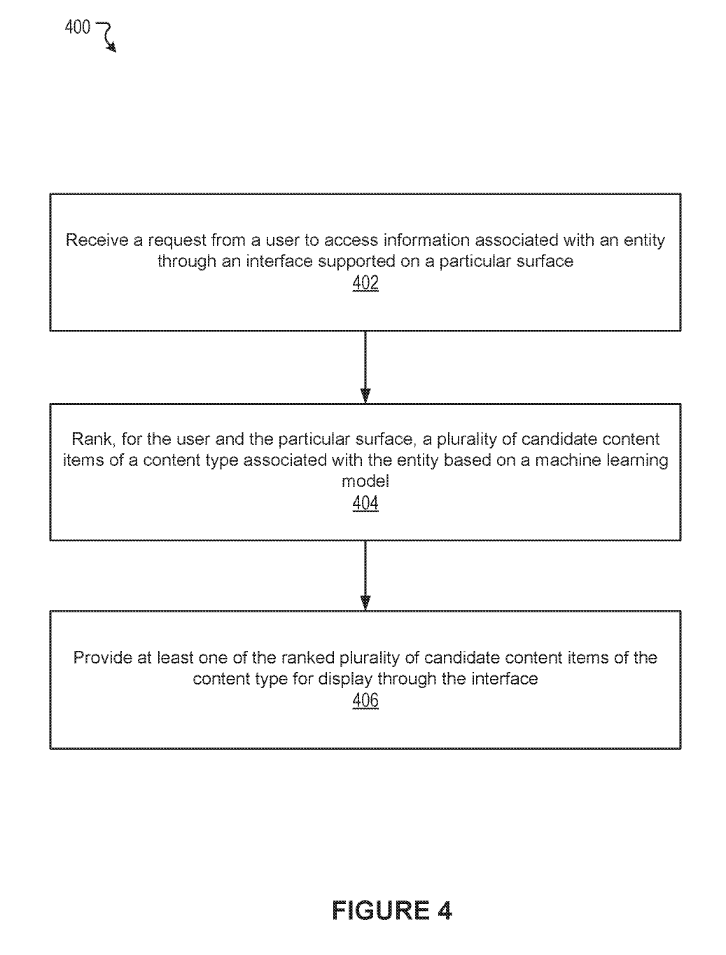

FIG. 4 illustrates an example first method 400 for dynamically determining content associated with entities, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can receive a request from a user to access information associated with an entity through an interface supported on a particular surface. At block 404, the example method 400 can rank, for the user and the particular surface, a plurality of candidate content items of a content type associated with the entity based on a machine learning model. At block 406, the example method 400 can provide at least one of the ranked plurality of candidate content items of the content type for display through the interface. Other suitable techniques that incorporate various features and embodiments of the present disclosure are possible.

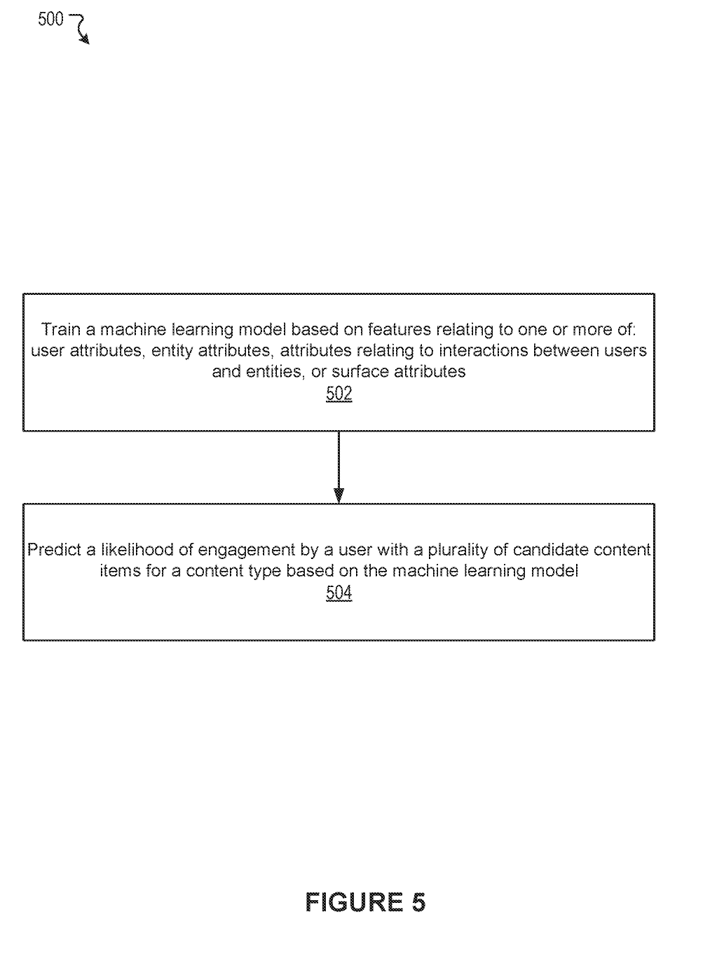

FIG. 5 illustrates an example second method 500 for dynamically determining content associated with entities, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a machine learning model based on features relating to one or more of: user attributes, entity attributes, attributes relating to interactions between users and entities, or surface attributes. At block 504, the example method 500 can predict a likelihood of engagement by a user with a plurality of candidate content items for a content type based on the machine learning model. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a dynamic surface content module 646. The dynamic surface content module 646 can be implemented with the dynamic surface content module 102, as discussed in more detail herein. In some embodiments, one or more functionalities of the dynamic surface content module 646 can be implemented in the user device 610.

### Hardware Implementation

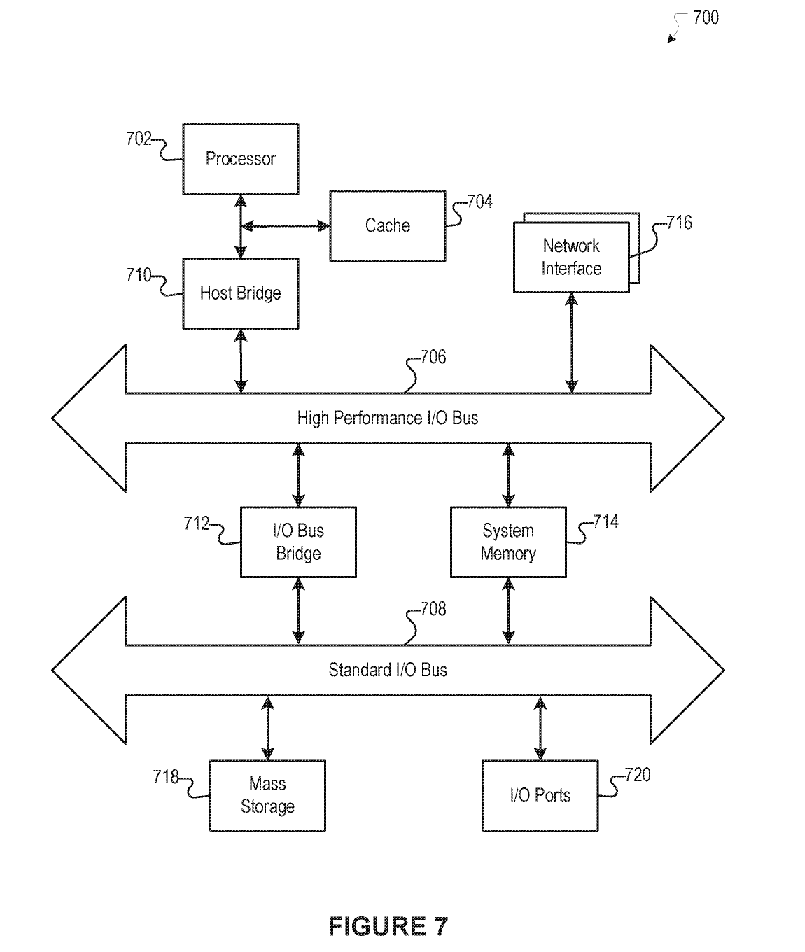

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a request from a user to access information associated with an entity through an interface supported on a particular surface;
ranking, by the computing system, for the user and the particular surface, a plurality of candidate content items of a content type associated with the entity based on a machine learning model; and
providing, by the computing system, at least one of the ranked plurality of candidate content items of the content type for display through the interface.

2. The computer-implemented method of claim 1, further comprising training the machine learning model to predict a likelihood of engagement by the user with the plurality of candidate content items.

3. The computer-implemented method of claim 2, wherein the machine learning model is trained based on features relating to one or more of: user attributes, entity attributes, attributes relating to interactions between users and entities, or surface attributes.

4. The computer-implemented method of claim 1, wherein the entity is represented as a page provided in a social networking system and the page includes one or more sections each associated with a particular content type associated with the entity.

5. The computer-implemented method of claim 4, wherein the machine learning model is trained to rank candidate content items for each section of the page.

6. The computer-implemented method of claim 1, wherein the content type relates to or more of: a call-to-action (CTA), an action bar, tabs, content items of a tab, cards of a tab, a workflow, an about section, a community section, a cover section, product information, or service information.

7. The computer-implemented method of claim 6, wherein the content type is the CTA and the plurality of candidate content items are CTAs selected from a list of CTAs based on an objective associated with the entity.

8. The computer-implemented method of claim 7, wherein the objective associated with the entity is determined based on one or more of: a category associated with the entity or a template for creating a representation of the entity.

9. The computer-implemented method of claim 1, wherein the particular surface is determined based on one or more of: an application or a platform.

10. The computer-implemented method of claim 9, wherein the application includes one or more of: a social networking application, a messaging application, a photo sharing application, or an external application, and wherein the platform includes one or more of: a mobile platform or a desktop platform.

11. A system comprising:
at least one hardware processor; and
a memory storing instructions that, when executed by the at least one processor, cause the system to perform:
receiving a request from a user to access information associated with an entity through an interface supported on a particular surface;
ranking, for the user and the particular surface, a plurality of candidate content items of a content type associated with the entity based on a machine learning model; and
providing at least one of the ranked plurality of candidate content items of the content type for display through the interface.

12. The system of claim 11, wherein the instructions further cause the system to perform training the machine learning model to predict a likelihood of engagement by the user with the plurality of candidate content items.

13. The system of claim 12, wherein the machine learning model is trained based on features relating one or more of: user attributes, entity attributes, attributes relating to interactions between users and entities, or surface attributes.

14. The system of claim 11, wherein the entity is represented as a page provided in a social networking system and the page includes one or more sections each associated with a particular content type associated with the entity.

15. The system of claim 14, wherein the machine learning model is trained to rank candidate content items for each section of the page.

16. A non-transitory computer readable medium including instructions that, when executed by at least one hardware processor of a computing system, cause the computing system to perform a method comprising:
receiving a request from a user to access information associated with an entity through an interface supported on a particular surface;
ranking, for the user and the particular surface, a plurality of candidate content items of a content type associated with the entity based on a machine learning model; and
providing at least one of the ranked plurality of candidate content items of the content type for display through the interface.

17. The non-transitory computer readable medium of claim 16, wherein the method further comprises training the machine learning model to predict a likelihood of engagement by the user with the plurality of candidate content items.

18. The non-transitory computer readable medium of claim 17, wherein the machine learning model is trained based on features relating to one or more of: user attributes, entity attributes, attributes relating to interactions between users and entities, or surface attributes.

19. The non-transitory computer readable medium of claim 16, wherein the entity is represented as a page provided in a social networking system and the page includes one or more sections each associated with a particular content type associated with the entity.

20. The non-transitory computer readable medium of claim 19, wherein the machine learning model is trained to rank candidate content items for each section of the page.
